(19) United States
(12) Patent Application Publication
(10) Pub. No.: US 2006/0284097 A1
(43) Pub. Date: Dec. 21, 2006

(54) Simultaneous scanning by computed tomography (CT) and single photon emission computed tomography (SPECT) with automatic patient motion correction

(76) Inventors: Sharon Xiaorong Wang, Hoffman Estates, IL (US); James Frank Caruba, Bartlett, IL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/452,825

(22) Filed: Jun. 14, 2006

Related U.S. Application Data
(60) Provisional application No. 60/691,334, filed on Jun. 16, 2005.

(51) Int. Cl. G01T 1/166

(52) U.S. Cl. 250/363.04

(57) ABSTRACT

A method for simultaneous CT and SPECT imaging in which CT data is acquired during each SPECT data acquisition window. SPECT scanning requires several seconds or minutes of gamma detection at each of several angular positions. CT scanning requires short duration X-ray pulses at each of several angular positions. In the present invention, the X-rays pulses are timed to occur at approximately a midpoint of time of each SPECT gamma detection period. Preferably, the SPECT gamma detection is disabled during each X-ray pulse. Consequently, there is improved position registration between CT and SPECT data. Also included is an embodiment in which SPECT data is collected synchronously with a patient's breathing. Accurate registration between CT images and SPECT images is provided.

### CROSS-REFERENCE TO RELATED APPLICATION AND CLAIM FOR PRIORITY

This application claims priority under 35 U.S.C. § 119(e) from copending U.S. Provisional Patent Application Ser. No. 60/691,334 filed on Jun. 16, 2005.

### FIELD OF THE INVENTION

The present invention relates generally to diagnostic imaging systems. More particularly, the present invention relates to a method for simultaneously performing computed tomography (CT) scanning and single photon emission computed tomography (SPECT) scanning. The present method provides improved registration between CT and SPECT images, and allows for improved correction of patient movement.

### BACKGROUND OF THE INVENTION

Computed tomography (CT) scanning (i.e., using an external X-ray source) and single photon emission computed tomography (SPECT) scanning (i.e., using an infused radiopharmaceutical as a source of gamma ray emissions) are well known methods for diagnostic medical imaging. CT scanning employs multiple X-ray images taken in multiple directions to generate a 3-dimensional image or multiple tomographic image “slices.” SPECT scanning employs a gamma-emitting radiopharmaceutical ingested by a patient or injected into a patient. Multiple gamma ray images are taken in multiple directions to generate a 3-dimensional SPECT image or multiple slices. CT and SPECT scanning provide different information. For example, CT scanning generally has higher resolution and is superior for providing structural data such as the structure of bones, organs, etc. SPECT scanning generally has lower resolution but provides more useful information regarding the functional condition of body tissues and systems such as the cardiovascular system. SPECT is superior for indicating the presence of soft tissue tumors or decreased blood flow to certain organs or areas of the body, for example. The complementary strengths of CT and SPECT scanning can be provided simultaneously by performing both methods in a single apparatus and imaging session. However, combining CT and SPECT scanning presents technical challenges because CT and SPECT require different scan times and have different sensitivities to patient motion.

SPECT scanning requires a relatively long duration data acquisition period of about 30 minutes for a typical clinically sufficient image. Typically, several dozen SPECT data acquisitions are performed at different angles during this period. Consequently, patient movement is a problem in SPECT scanning. Excessive motion of a patient can result in scan failure. Thoracic cage movement caused by breathing is a significant problem in SPECT scanning.

By comparison, CT scanning is relatively fast and can typically be performed during one breath-hold by a patient.

Fusion of CT and SPECT images often is inaccurate because of inevitable patient movement and breathing. Also, vibrations caused by movement of the radiation sources and detectors can create inaccuracies in image registration or rendering.

Another significant problem is that, in conventional combined systems, CT data acquisition must occur either before or after SPECT data acquisition. The delay between CT and SPECT data acquisition prevents accurate image registration if there is patient movement.

Accordingly, there is a need in the art for improved methods for simultaneous or combined CT and SPECT scanning. It would be particularly beneficial to provide a method for combined CT and SPECT scanning that can correct for inaccuracies caused by patient motion such as motion caused by respiration. Also, it would be beneficial to provide a method for combined CT and SPECT scanning that does not require a time delay between CT data acquisition and SPECT data acquisition.

### SUMMARY OF THE INVENTION

The present invention includes a method for computed tomography (CT) imaging and single photon emission computed tomography (SPECT) imaging. In the present method, gamma rays emitted from a radiopharmaceutical inside a patient are detected. During a gamma ray detection time window, the patient is exposed to an X-ray pulse. X-rays transmitted through the patient are detected. Gamma rays are detected, and X-ray pulses are created at each of several angular positions. Registration is excellent between X-ray (CT) and gamma (SPECT) imaging because X-ray images are captured during the gamma ray detection windows. Preferably, the X-ray pulses occur at or near a midpoint of the associated gamma detection window.

Preferably, gamma rays are not detected during the X-ray pulse. The gamma detectors can be disabled during the X-ray pulse, or data from the gamma detectors during the X-ray pulse can be discarded. Gamma rays can be detected continuously during the gamma detection window (except for the duration of the X-ray pulse).

The gamma detection window can be divided into sub-windows separated by “knockout” periods. Gamma rays are not detected (or, equivalently, gamma detection data is discarded) during the knockout periods. The sub-windows are timed to synchronize with the patient's respiratory cycle so that the effects of respiratory motion are reduced or eliminated.

The present invention also includes a CT/SPECT imaging apparatus having a computer-readable medium encoded with instructions for performing the method of the present invention. In the present method, an X-ray pulse for CT-imaging is produced during a gamma detection window.

### BRIEF DESCRIPTION OF THE FIGURES

FIG. 1 (Prior Art) shows an imaging device for simultaneously performing CT and SPECT scanning, which can be used in accordance with the present invention;

FIG. 2 shows three synchronized graphs illustrating a combined CT/SPECT scanning method according to the present invention;

FIG. 3 shows three synchronized graphs illustrating a combined CT/SPECT scanning method according to the present invention, in which imaging is timed to eliminate artifacts or inaccuracies caused by respiratory motion; and

FIG. 4 shows an alternative embodiment in which gamma detection is not performed at the same respiratory cycle as the X-ray pulse.

### DETAILED DESCRIPTION

The present invention provides a method for simultaneous CT scanning and SPECT scanning. In SPECT scanning, gamma detectors acquire data for several seconds or minutes at each of several angular positions. In CT scanning, a short duration (e.g. microseconds) X-ray pulse is created and detected at each of several angular positions. In the present invention, a CT X-ray pulse is created during (e.g. at approximately a midpoint of) each SPECT gamma detector acquisition window. In other words, a CT X-ray image can be taken at about ½ of each SPECT gamma detection window. The SPECT gamma detectors are disabled during the X-ray pulses (thereby preventing X-ray detection by the gamma detectors). Accordingly, there is no significant time delay between acquisition of CT and SPECT imaging data. Also, the CT and SPECT images can have accurate mechanical registration. Additionally, the gamma detection window can be divided into sub-windows that are synchronized with patient breathing or cardiac motion.

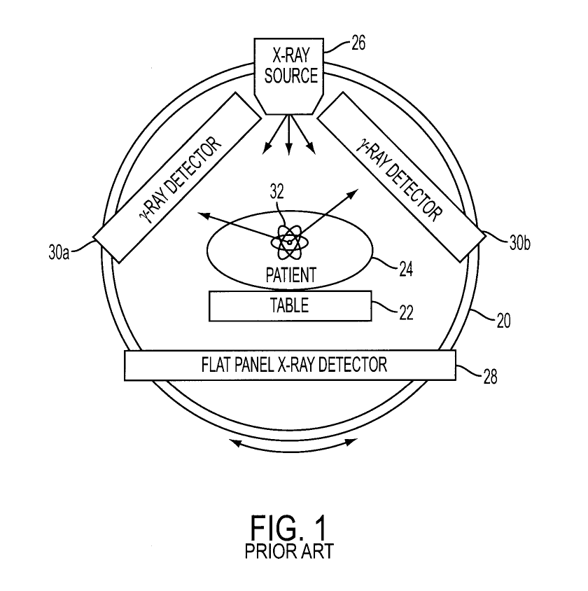

FIG. 1 shows a diagnostic imaging machine capable of performing the method of the present invention. The machine of FIG. 1 can simultaneously perform CT scanning and SPECT scanning. The machine has a rotatable gantry 20, rotatable around an axis perpendicular to the page. A non-rotating table 22 is disposed near the center of the gantry 20, and a patient 24 is lying on the table 22. An X-ray source 26 is attached to the gantry 20 (the attachment may be either adjustable or non-adjustable with respect to the gantry). A flat panel X-ray detector 28 is attached to the gantry 20 opposite the X-ray source 26. Gamma detectors 30a, 30b (collectively gamma detectors 30) are attached to the gantry 20. The gamma detectors 30 detect radiation from a gamma-emitting radiopharmaceutical 32 inside the patient 24.

The gamma detectors 30 typically will be scintillation detectors, either being constructed of solid-state scintillator detector material, or having a photomultiplier tube photosensor optically coupled to a scintillation crystal material.

As known in the art, in operation, the flat panel X-ray detector 28 acquires multiple images (at multiple angles) which can be computer processed to create a 3-dinemsional CT image of the patient 24. Similarly, the gamma detectors 30 acquire data (at multiple angles) which can be computer processed to create a 3-dimensional SPECT image of the patient 24. The CT image (or X-ray data) and SPECT image (or gamma ray data) can be combined according to well known methods that preserve and enhance the complementary advantages of CT and SPECT imaging.

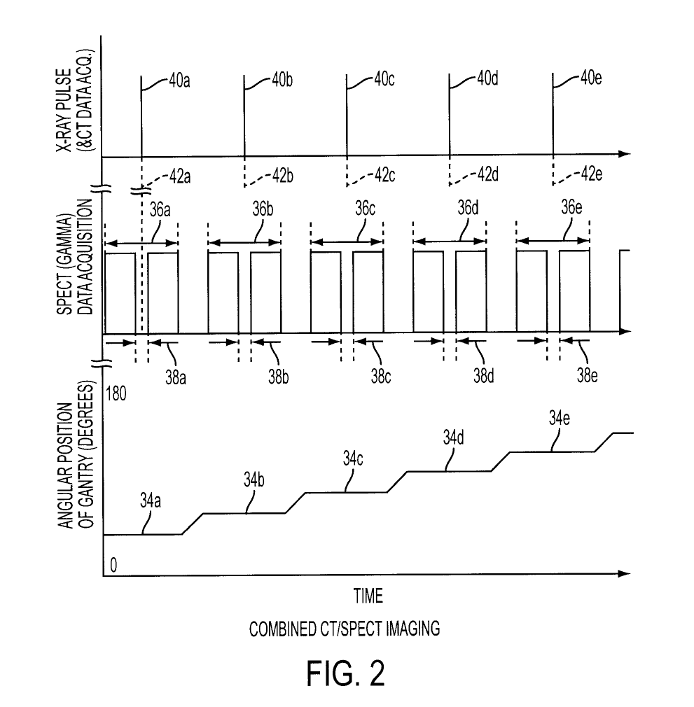

FIG. 2 shows three synchronized graphs illustrating a combined CT/SPECT scanning method according to the present invention. In the present method, the CT X-ray source 26, X-ray detector 28, and gamma detectors 30a, 30b are preferably rotated together by moving the gantry 20. The angular position of the gantry 20 is stopped at several angular positions 34a, 34b, 34c, 34d, 34e, etc. CT and SPECT data is acquired at each angular position. The angle between each position can be about 1-10 degrees (e.g., about 3 degrees). The gantry may be moved over 180 degrees, as illustrated in FIG. 2, or 270 or 360 degrees, for example.

At each angular position 34a-34e, the gamma ray detectors 30a, 30b are activated (i.e. enabled to detect gamma rays from radiopharmaceutical source 32) during gamma detection windows 36a-36e, respectively. Each gamma detection window 36 includes a gap 38a-38e. During the gaps 38, the gamma ray detectors 30a, 30b are disabled; gamma rays from the radiopharmaceutical are not detected during the gaps 38. In the present invention, X-ray pulses 40a-40e are produced and detected (e.g. by flat panel 28) during the gaps 38. Preferably, the X-ray detector (e.g. flat panel 28) detects X-rays only during the gaps 38 in gamma ray detection. The gamma detection windows 36 will typically be about 10 seconds to 3 minutes long, more typically about 20-40 seconds long. The gaps 38 will typically be about 100 microseconds to several milliseconds long, more typically about 200-800 microseconds long. Preferably, the gaps 38 are slightly longer (e.g. 0-10% longer) than the X-rays pulses. The X-ray pulses can be about 300 microseconds long, for example. The flat panel X-ray detector 28 can be enabled for the same duration as the gap 38, or slightly longer than the gap.

Optionally, the gaps 38 are longer in duration than the X-ray pulses 40. In this case, there will be a dead time between the X-ray pulse and the gamma detector activation.

Preferably, the gaps 38 are centered at midpoints in time 42a-42e of the gamma detection windows 36. Optionally, the gaps 38 can be slightly before or after the midpoints 42. For example, the gaps 38 and X-ray pulses 40 can occur 10, 20 or 30% before or after, as a percentage of the total duration of the gamma detection window 36.

Also, in the present invention it is possible to have one or more gamma detection windows 36 that do not have a gap 38, and do not have an associated X-ray pulse 40 (i.e. a conventional SPECT gamma detection window). In other words, in the present invention, it is not required for every gamma detection window 36 to have an associated X-ray pulse 40. In the present invention and appended claims, it is only necessary to have at least one gamma detection window 36 having a gap 38 and associated X-ray pulse 40.

Also, it is noted that the gamma detectors 30 can detect gamma rays continuously during the gaps 38. In this case, gamma detection data collected during the gaps may be discarded or ignored when processing images. Both possibilities are equivalent in the invention, and within the scope of the appended claims.

Preferably, the X-ray source 26, flat panel detector 28, and gamma detectors 30 are rotated together during the image acquisition. Alternatively, the X-ray source 26 and X-ray detector 28 may be moved independently of the gamma detectors 30.

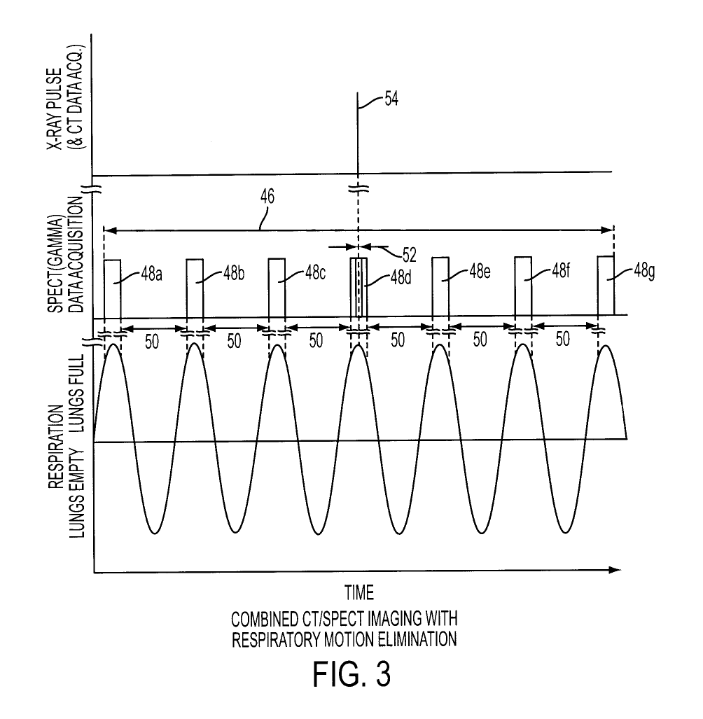

FIG. 3 shows three synchronized graphs illustrating a method for combined CT/SPECT scanning with compensation for respiratory movement according to an embodiment of the invention. FIG. 3 shows data acquisition at a single angular position. To create a 3-dimensional image, the present invention will typically employ dozens of data acquisitions like the one illustrated in FIG. 3, with each data acquisition taken at a different angular position. Each data acquisition can occur at a position separated by about 3 degrees, for example.

The angular position of the gamma detectors is not changed during the gamma detection window 46. The gamma detection window 46 can be about 20, 40, or 60 seconds, or longer, for example.

The bottom graph of FIG. 3 illustrates a respiratory cycle associated with corresponding motion of the patient's body, such as caused by expansion and contraction of the lungs/abdominal cavity. Typically, a patient will have about 12-20 respiratory cycles per minute. The entire duration of the graphs of FIG. 3 may comprise about 30 seconds.

A single gamma detection window 46 is divided into several sub-windows 48a, 48b, 48c, 48d, 48e, 48f, 48g. The sub-windows 48 are separated by “knock-out” periods 50. SPECT gamma detection occurs only during the sub-windows 48, e.g., at the same phase of each respiratory cycle. The gamma detectors 30 are disabled (or data from the detectors 30 is discarded) during the knock-out periods 50. The sub-windows 48 are synchronized with the respiratory motion of the patient. Specifically, the sub-windows 48 are timed to each occur at the same point or phase in the patient's respiratory cycle. In the specific example of FIG. 3, the sub-windows are timed to occur when the lungs are fully inflated. Alternatively, the sub-windows 48 could be timed to occur when the lungs are deflated, or at a midpoint of inhalation or exhalation.

In the embodiment of FIG. 3, the respiration of the patient should be monitored so that the gamma detectors can be synchronized to the patient's breathing. Alternatively, the patient can be instructed to breath synchronously with the operation of the machine. For example, the patient can be instructed to pause respiratory motion for a period of 1-3 seconds during every respiratory cycle. In either case, the sub-windows 48 are synchronized with the patient's breathing.

In an alternative embodiment, the gamma detectors 30 remain enabled during the entire gamma detection window 46, and data gathered during the knock-out periods 50 is discarded or ignored by an image processing computer. This alternative embodiment will of course provide images equivalent to an embodiment in which the gamma detectors 30 are turned off (e.g. powered down) during the knockout periods 50.

The embodiment of FIG. 3 is similar to the embodiment of FIG. 2, with the exception that data is not acquired during knock-out periods 50 (or, alternatively, data acquired during knock-out periods 50 is not used for image processing). In other words, in the embodiment of FIG. 3, the gamma detectors 30 are disabled when the respiratory phase of the patient does not match the desired phase for imaging.

In the embodiment of FIG. 3, at least one of the sub-windows 48 has a gap 52 during which the gamma detectors 30 are disabled, or gamma detector data is ignored. Preferably, the gap 52 occurs at approximately a midpoint of the associated sub-window 48d. During the gap 52, the flat panel X-ray detector 28 is enabled, and an X-ray pulse 54 is produced by the X-ray source 26, thereby capturing a single X-ray frame for 3-dimensional CT imaging. In an alternative embodiment, more than one sub-window 48 has a gap 52 and an associated X-ray pulse 54.

Gamma detection data collected during the sub-windows 48 is preferably aggregated. The aggregated gamma detection data for all the sub-windows 48 is used for SPECT image processing as if it were collected during a single continuous gamma acquisition.

The total, integrated gamma detection time of all the sub-windows 48 will greatly influence the resolution and quality of the SPECT image. Preferably, the total time of all the sub-windows 48 (in a single gamma detection window 46) added together will be sufficient to collect about 50,000 to 100,000 gamma ray events or “counts.”

In the present invention, the sub-windows 48 typically can be about 0.5-3 seconds in duration. The knock-out periods 50 can typically be about 2-5 seconds long. The durations of the sub-windows 48 and knockout periods 50 will depend on the breathing needs of the patient and other factors. In the present invention, it is understood that performance tradeoffs exist between the duration of the sub-windows 48, image resolution, and total scan time. Very short sub-windows 48 will reduce the effects of respiratory motion (which is beneficial for image accuracy), but will also tend to reduce the number of gamma rays collected (which is detrimental for image resolution). The number of detected gamma-rays can be increased by increasing the total imaging time, but this will tend to reduce imaging throughput and increase imaging cost.

The gap 52 can be very slightly longer than the X-ray pulse from the source 26. For example, the X-ray pulse 54 can be about 100-500 microseconds, and the gap can be about 150-600 microseconds.

The imaging method illustrated in FIG. 3 provides exceptional registration between CT images and SPECT images, while at the same time avoiding blurring effects from respiratory motion. The CT image and SPECT image have very good registration because each X-ray pulse occurs during the associated gamma detection window, and can occur at the midpoint of the gamma detection window.

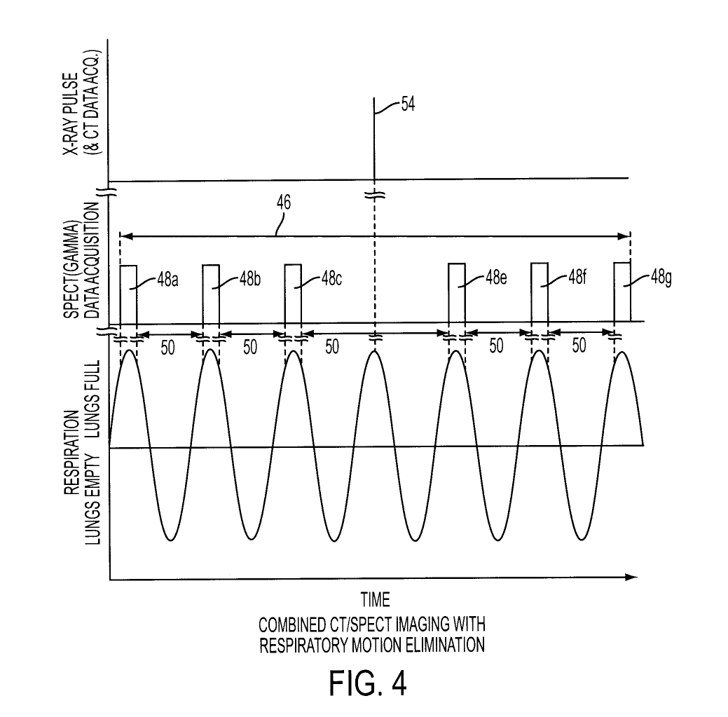

FIG. 4 shows an alternative embodiment in which the sub-window associated with the X-ray pulse 54 (sub-window 48d, in FIG. 3) is omitted. In this embodiment, the total number of detected gamma rays will tend to be reduced because of the reduced number of sub-windows 48.

It will be clear to one skilled in the art that the above embodiment may be altered in many ways without departing from the scope of the invention. Accordingly, the scope of the invention should be determined by the following claims and their legal equivalents.

What is claimed is:

1. A method for simultaneous computed tomography (CT) imaging and single photon emission computed tomography (SPECT) imaging of a patient, comprising the steps of:
a) detecting gamma rays during a gamma detection time window, wherein the gamma rays are emitted by a radiopharmaceutical inside said patient,
b) during the gamma detection window, exposing the patient to an X-ray pulse, and
c) detecting X-rays transmitted through the patient by the X-ray pulse;
d) repeating steps (a), (b) and (c) at each of a plurality of angular positions with respect to said patient.

2. The method of claim 1, wherein gamma rays are not detected during the X-ray pulse.

3. The method of claim 1, wherein step (b) occurs at approximately at a midpoint in time of the gamma detection window.

4. The method claim 1, wherein the gamma detection window is divided into sub-windows separated by knock-out periods, wherein the sub-windows and X-ray pulse are timed to occur at similar stages in the patient's respiratory cycle.

5. The method of claim 1, wherein the patient is exposed to an X-ray pulse within +/−25% of a midpoint of the gamma detection window.

6. The method of claim 1, wherein the gamma rays are continuously detected during the gamma detection window, except for a gap synchronized with the X-ray pulse during which gamma rays are not detected.

7. An apparatus for performing simultaneous CT and SPECT imaging of a patient, comprising:
a) a gamma detector for detecting gamma rays emitted by a radiopharmaceutical inside the patient;
b) an X-ray source for producing an X-ray pulse directed toward the patient;
c) an X-ray detector for detecting X-rays from the X-ray source transmitted through the patient;
d) a computer readable medium for storing a computer-executable program having instructions for performing the following steps:
1) detecting gamma rays during a gamma detection window;
2) exposing the patient to an X-ray pulse during the gamma detection window;
3) detecting X-rays transmitted through the patient by the X-ray pulse; and
4) repeating steps (1), (2) and (3) at each of a plurality of angular positions.

8. The apparatus of claim 7, wherein the patient is exposed to an X-ray pulse within +/−25% of a midpoint of the gamma detection window.

9. The apparatus of claim 7, wherein the X-ray source, the X-ray detector, and the gamma detector are attached to a same gantry rotatable around the patient.

10. The apparatus of claim 7, further comprising instructions for dividing the gamma detection window into sub-windows separated by knock-out periods, wherein the sub-windows and X-ray pulse are timed to occur at similar stages in the patient's respiratory cycle.

11. A method for simultaneous computed tomography (CT) imaging and single photon emission computed tomography (SPECT) imaging, comprising the steps of:
a) detecting gamma rays during a gamma detection window, wherein the gamma rays are emitted by a radiopharmaceutical inside a patient,
b) during the gamma detection window, exposing the patient to an X-ray pulse, and
c) detecting X-rays transmitted through the patient during the X-ray pulse;
d) repeating steps (a), (b) and (c) at each of a plurality of angular positions; and
wherein gamma rays are not detected during the X-ray pulse.

12. The method of claim 11, wherein step (b) occurs at approximately at a midpoint in time of the gamma detection window.

13. The method claim 11, wherein the gamma detection window is divided into sub-windows separated by knock-out periods, wherein the sub-windows and X-ray pulse are timed to occur at similar stages in the patient's respiratory cycle.

14. The method of claim 11, wherein the patient is exposed to an X-ray pulse within +/−25% of a midpoint of the gamma detection window.

15. The method of claim 11, wherein the gamma rays are continuously detected during the gamma detection window, except for during the X-ray pulse.
